(19) United States
(12) Patent Application Publication
(10) Pub. No.: US 2002/0083963 A1
(43) Pub. Date: Jul. 4, 2002

(54) Multi-blade, rotary blade cleaner

(76) Inventors: Rodney B. Proulx, Webster, NY (US); Nero R. Lindblad, Ontario, NY (US); Richard L. Carlston, Rochester, NY (US); James F. Smith, Ontario, NY (US)

Correspondence Address: OLIFF & BERRIDGE, PLC, P.O. BOX 19928, ALEXANDRIA, VA, 22320, US

(21) Appl. No.: 09/749,414

(22) Filed: Dec. 28, 2000

(51) Int. Cl. B08B 1/02

(52) U.S. Cl. 134/6; 15/102; 15/230.16; 15/256.5; 15/256.52

(57) ABSTRACT

A rotary, multi-bladed cleaner provides increased life expectancy, up to 15-25 times the life of a single blade cleaner. Such a cleaner has been found to be highly reliable due to its ability to frequently change brush surfaces and by provision of a redundant system that enables multiple blades to contact the surface to be cleaned at once. The blade cleaner has a paddle-wheel type cross-sectional shape with a plurality of radially extending blades spaced around the periphery thereof. The blades are spaced to be closely adjacent one another such that one and preferably two or more blades contact the residual image at one time. The rotary blade cleaner is preferably rotated at a slow rotation rate with the blades being in contact for only a limited time before being displaced by the next blade(s). Such a rotary cleaner is particularly suited for cleaning residual toners and inks from a photoreceptive surface.

### BACKGROUND OF THE INVENTION

1. Field of Invention

The invention relates to a rotary cleaner having multiple blades that contact a surface to be cleaned. The cleaning blade is particularly suited for use in xerographic or electrophotographic devices to remove residuals, such as liquid or dry toner.

2. Description of Related Art

There have been proposed several blade mechanisms to remove residual components from a photoreceptive surface in a xerographic or electrophotographic 10 device. One technique employed involves the use-of a compliant blade held against the surface. Such blade cleaners, often accompanied by irrigating and agitation devices, are common in low to mid-volume electrophotographic machines and digital presses equipped with liquid imaging systems. Such blade cleaners are rarely used in long-run, high reliability, high-speed systems as they have relatively short mean-time-to-failure when compared to magnetic brush-type cleaning systems employed in dry xerographic machines.

Consistent, reliable cleaning performance is required to satisfy the needs of customers in the graphic arts market. Currently, production in this market is from offset presses, plate-makers (offline and direct) and high-end workstations. All of these graphic arts machines are designed to deliver hour after hour of dependable performance. Presses require less than one service call per year with outputs in the tens of millions of sheets between calls. This means that a blade-based cleaning subsystems reliability must be high, much higher than existing blade-based cleaners used today.

The present mainline approach to removing residual liquid imaging material from the surface of an image carrier, such as a photoreceptor, image bearer, transfer belt, etc., in a liquid imaging system is use of a foam agitation roll, a spray bar, and a compliant blade in combination. This cleaning system has been employed to remove residual ink “cake” for reclamation, and residual ink and Isopar™ image carriers following electrostatic transfer at process speeds of 30 inches per second (ips). However, there are problems with this system.

### SUMMARY OF THE INVENTION

There is a need for an improved cleaning system that has an increased failure interval.

There also is a need for such a system to retain simplicity, effectivity and low cost.

It is an object of the invention to provide a rotary, multi-bladed cleaner that can provide increased life expectancy, up to 15-25 times the life of a single blade cleaner. Moreover, it is another object of the invention to provide a highly reliable cleaner due to its ability to frequently change brush surfaces and by provision of a redundant system that enables multiple blades to contact the surface to be cleaned at once.

These and other objects are achieved by a blade cleaner that has a paddle-wheel type cross-sectional shape with a plurality of radially extending blades spaced around the periphery thereof. The blades are spaced to be closely adjacent one another such that one and preferably two or more blades contact the residual image at one time. The rotary blade cleaner blades are preferably skewed. The rotary blade can be rotated at a slow rotation rate with the blades being in contact for only a limited time before being displaced by the next blade(s).

### BRIEF DESCRIPTION OF THE DRAWINGS

The foregoing and further objects, features and advantages of the present invention will become apparent from the following description of preferred embodiments with reference to the accompanying drawings, wherein:

FIG. 1 is an end view of a multi-blade rotary cleaner according to the invention;

FIG. 2 is a side view of the multi-blade rotary cleaner of FIG. 1 according to the invention;

FIG. 3 is a perspective view of the multi-blade rotary cleaner of FIG. 1 according to the invention;

FIG. 4 shows a graph of test results showing minimum cleaner speeds for dry toner and diluted ink systems, as well as 24% solids ink systems;

FIG. 5 shows a schematic of a liquid electrophotographic system with the inventive multi-bladed rotary cleaner according to the invention; and

FIG. 6 shows a schematic of a dry electrophotographic system with the inventive multi-bladed rotary cleaner according to the invention.

### DETAILED DESCRIPTION OF PREFERRED EMBODIMENTS

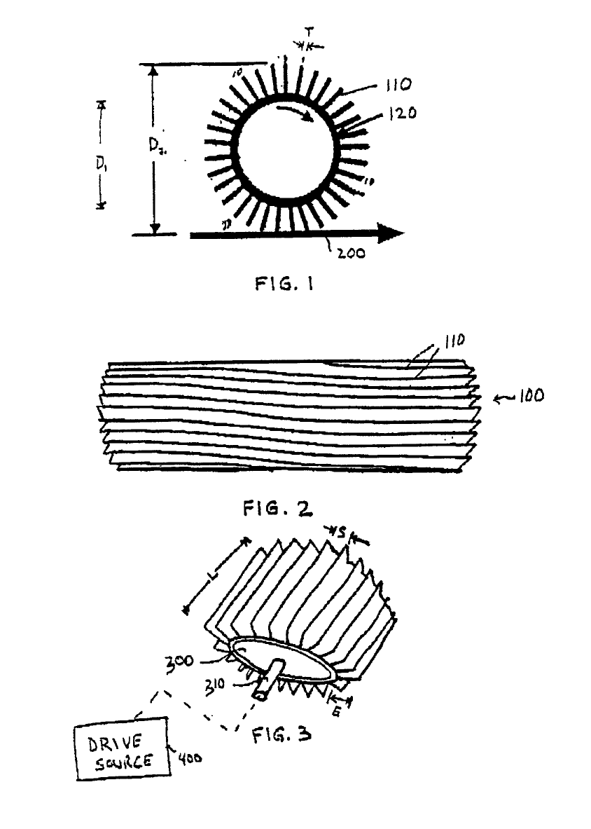

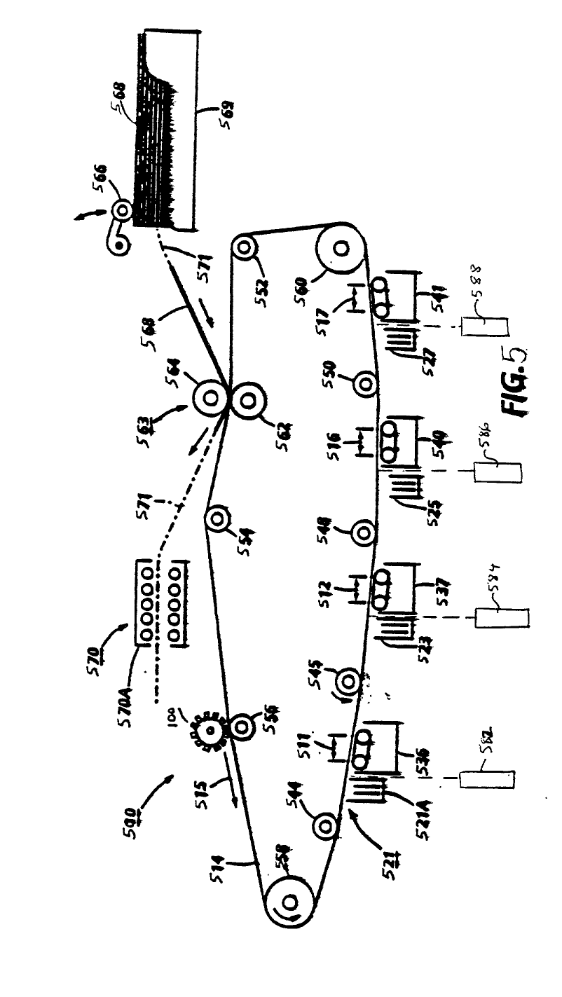

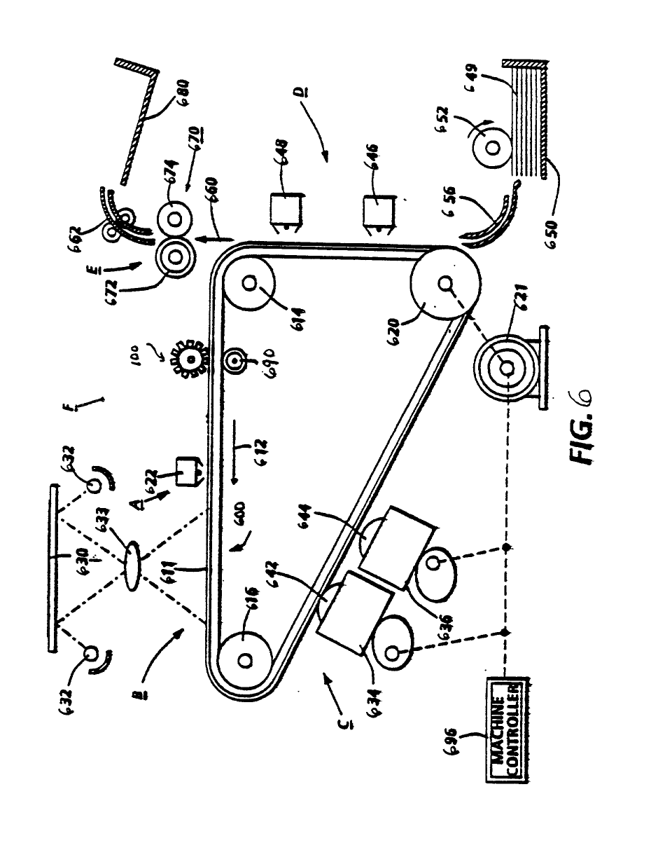

A first embodiment of the present invention will be described with reference to FIGS. 1-3, which show a multi-bladed rotary cleaner 100 applicable to both dry and liquid toner imaging systems. For a general understanding of a printing machine in which the invention may be incorporated, reference will be made to FIG. 5, which depicts schematically various components of an exemplary liquid electrophotographic system. FIG. 6 depicts schematically an exemplary dry electrophotographic system to which the invention can be incorporated. While the rotary cleaner is well suited to these types of systems, it should become equally evident that the invention is well suited to other cleaning applications beyond the exemplary embodiments shown, such as offset presses and other graphic arts printing systems in general, and to other general applications in which residual materials on a surface need to be removed.

Referring back to FIGS. 1-3, a cross-section of a molded, compliant multi-bladed cleaner 100 is shown having a plurality of blades 110 radiating from a base 120, which is preferably cylindrical. Rotary cleaner 100 is used to clean residuals from a surface, such as image bearing surface 200. Rotary cleaner 100 is suitable for installation onto a mandrel or other cylindrical mount, such as the shaft-driven mandrel 300 shown in FIG. 3, which is operatively driven by a drive source 400, which can be any conventional or subsequently developed drive source such as a D.C. motor or servo motor, connected to a shaft 310 of the mandrel through a conventional (unshown) linkage. The driving is preferably continuous during use, but may be indexed. For example, the rotary cleaner may be incrementally indexed after a predetermined number of images have been cleaned.

In this exemplary embodiment of FIGS. 1-3, rotary cleaner 100 has a length L that is preferably at least as long as the transverse width of the surface being cleaned. Rotary cleaner 100 also has a predefined roll diameter D1, a plurality of radially projecting blades 110 spaced around the periphery of the blade cleaner at a preferably constant pitch (substantially uniform blade spacing) S, a blade thickness T, and a blade extension length E, which results in a blade cleaner having a total diameter D2. These variables are selected based on several criteria. The number of blades, the spacing, and the circumference D2 are selected for a particular application based on many criteria, which can vary greatly depending on the particular application. Some of these variables are inter-related and thus not completely arbitrary. For example, the number of blades is dependent on the selected circumference and spacing. Conversely, once a desired number of blades is determined, the necessary circumference can be mathematically determined given a specified spacing.

One factor in selecting the desirable number of blades is based on the expected life expectancy of the unit (i.e., printing machine) and a desirable service interval. By increasing the number of blades, the life expectancy can be increased (assuming a given wear rate per blade) as a larger number of blades will decrease the total time that each blade will be in contact with the surface given a constant rotation speed. Furthermore, the number of blades may be selected based on a desirable rotation rate and a selection of an adequate time to clean the blade surfaces before they again contact the image bearing surface during a subsequent rotation cycle. Also, the number of blades may be determined mathematically based on a maximum design s diameter of a cleaner that can fit in a given space and a predetermined minimum spacing between blades. These are just examples of various criteria that may go into the selection of an appropriate number of blades.

Each vane or paddle 110 preferably represents a full width compliant blade (i.e., a blade that extends the full length of a surface to be cleaned, such as a photoreceptor 200). Preferably, blades 110 are oriented in a skewed fashion similar to the spiral or slightly helical pattern shown in FIG. 2 (similar to that of a gravure roll) so that only a portion of each blade is used at any one time during cleaning. A better illustration of an exemplary embodiment of the rotary cleaner 100 is shown in FIG. 3.

In use, it is preferable for at least two blades 110 to contact the image bearer 200 at one time. That is, the interference between the image bearing surface and the multiple blades are adjusted so that at least one and preferably two (or more depending on application) blades are in contact With multiple blade contact, the likelihood of a damaged blade causing a streak defect is minimized. An optimum number of blades to contact has been found to be two to assure good cleaning and minimize drag on the image bearing surface.

Spacing S is selected based on several criteria, including material selection, modulus of the selected material, and extension length E, which are primary factors that determine deflection of individual blades 110. Spacing should not be so close that adjacent blades 110 contact one another during use. Moreover, the spacing should be enough to allow a sufficient flow channel for removal of the wiped material which will become entrapped between adjacent blades so as to prevent clogging or choking off of flow out of the channel. Further, spacing should be selected so that only a desired number of blades contact the surface at one time at a given section of the cleaner.

Various lab experiments have been conducted to verify the capability of the multi-blade cleaner 100 with imaging materials. Cleaning was accomplished using the rotary blade cleaner shown in FIG. 3. Blade cleaner 100 was made using a soft urethane. For use in removing liquid imaging toner and similar residuals, a preferred material was found to be a 70 Shore A durometer urethane rubber having a Young's modulus of about 1000 psi. However, the invention is not limited to this material and other known, conventional or subsequently developed blade surface materials may be used or selected depending on the particular residuals or surface being cleaned.

This exemplary blade cleaner 100 had a length L of about 38 mm (1.5″) for testing purposes but can be any suitable length, preferably a length that is the same as or longer than the surface to be cleaned, a diameter D of about 66 mm (2.6″) (as shown in FIG. 1), a blade spacing S of about 6.5 mm, a blade thickness T of about 2 mm (as shown in FIG. 1), and a blade extension length E of about 7 mm. With this dimensioning, the resultant rotary cleaner 100 had 30 blades 110. However, this example is illustrative and not meant to be limiting. Similar results can be achieved with altered variables.

The material being removed by rotary cleaner 100 during initial testing was a 24% solids CEP ink cake spread onto a glass surface. The rotary cleaning blade 100 was manually engaged and slowly rotated. Cleaning was found to be perfect, and the vanes/blades 110 were easily washed using Isopar™ by simply directing the washing fluid along and between the vanes 110. A quick and easy clean wash of the vanes is important to assure that the blades are clean before they rotate back into the cleaning nip. It is contemplated that such cleaning can be achieved by a routine, periodic manual flushing using a squirt bottle with a cleaning fluid such as Isopar or could be achieved with a mechanical washing station provided within the machine adjacent to rotary cleaner 100. A suitable washing station could include a mechanical sprayer positioned to move along the cleaner 100 and spray a fluid into the vanes and channels therebetween to wash the residuals to a waste tank or other removal facility (unshown). The washing station may also include a damp cloth or sponge that wicks or otherwise remove the residuals from the surface of cleaner 100. In the case of dry residuals, such as dry toner particles, the washing station may consist of a rotary brush, a vacuum source or air assist that cleans the residuals from the cleaner 100 without contacting the image bearing surface 200.

It has been found to be preferable to rotate the blades 110 of rotary cleaner 100 at a slow rate of speed, so that the cleaner slowly advances new clean blades continuously into a cleaning nip and carry the wiped residuals (such as ink) between the vanes to a suitable washing station (unshown). A suitable cleaner roll rpm depends on several parameters, such as the process speed of the xerographic device, the input residual mass density, the amount of residual mass on the cleaner roll that has to be cleaned, and the diameter of the cleaner roll. The diameter of the roll determines the number of cleaning blades. The dimensions of the blade, such as extension and thickness determine the normal cleaning force applied to remove the toner or ink. Thus, there are a number of parameters that affect cleaner roll rpm.

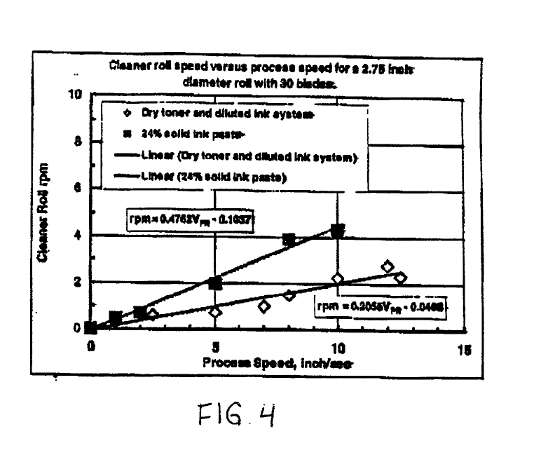

The inventive rotary cleaner is particularly suited for use in cleaning residual printing materials, such as dry toner, diluted ink and high solids content ink, in a xerographic or other printing or copying device. Such devices operate at one or more predefined process speeds. Additional testing was conducted to determine necessary rotary cleaner speeds to obtain adequate cleaning of such devices that operate at a given process speed. The data in FIG. 4 shows that the inventive rotary cleaner 100 can operate at a very low rpm compared to conventional brush cleaners, which typically operate at between 300 to 1000 rpm. This slower rotation allows ample time to clean the blades and eliminate toner or ink emissions from the cleaner.

Studies with both toner and ink systems show that for good, reliable cleaning, the minimum number of blades contacting the image should be two. The second blade serves as a backup blade in case the first blade fails. For example, if the first blade develops a nick that allows toner to leak under the blade, the second (or subsequent) blade will clean the toner passing under the nicked blade. Another example would be if the input mass density is high and the first blade is unable to remove all the residual and allows some to leak under the first blade. The second blade's function would be to remove the residual that leaked past the first blade. The two blades contacting the surface define a cleaning nip with a width NW, which is the circumference of the roll divided by the number of blades.

The rpm for the cleaner roll is typically specified in terms of the process speed of the xerographic device. When the process speed increases, the rpm of the cleaner roll correspondingly increases. This holds true generally for all types of rotary cleaners. From the studies conducted, cleaner rpm was varied with process speed. In particular, process speed was set constant and cleaner rpm was adjusted until good cleaning was achieved. This represents the minimum roll speed required for cleaning.

A simple empirical relationship that works well with both toner and diluted ink systems was found to follow the formula:

V_{b}=cleaner rpm=Vₚᵣ/5, [1]

where Vₚᵣ is the process speed of the xerographic device and V_{b} is the minimum rpm to achieve good cleaning.

A simple empirical relationship that works with a pasty ink having a high solids content, for example a 24% solids ink, was found to follow the formula:

V_{b}=cleaner rpm=Vₚᵣ/2, [1]

where Vₚᵣ is the process speed of the xerographic device and V_{b} is the minimum rpm to achieve good cleaning.

Cleaning blades used for xerographic or electrophotographic applications usually operate using one of a doctoring mode or a wiping mode motion. In the doctoring mode, a blade edge contacts a surface at a low angle and cleans using a chiseling or pushing motion. In the wiping mode, the blade edge is closer to perpendicular to the surface and cleans using a wiping motion. Applicants have found that the wiping mode is preferable as it eliminates any stick-slip motion when the surface being cleaned has low lubrication. As such, the invention provides a rotary cleaner that provides a plurality of blades that operate in the wiping mode.

In view of this testing, the exemplary rotary cleaner 100 has been found to be particularly applicable to single or multiple color liquid development electrophotographic imaging systems, such as the exemplary one shown in FIG. 5. The imaging system is formed by an electrophotographic or ionographic printer 500, with the associated printer housing and framework being omitted for clarity. Such electrophotographic printers are well known and as such, their operation will only be briefly mentioned to provide context for the type of residuals being cleaned by the inventive rotary cleaner 100. Printer 500 employs as an image retention member 514 an endless conductive belt having a dielectric layer (serving as an image bearing surface) on which multiple electrostatic images are created by an ion deposition process. Belt 514 moves in the direction of arrow 515 to advance successive portions of its surface through various processing stations disposed about the path of movement at a process speed of about 10 inches/second. Belt 514 is supported by rollers 558, 560 and 552. Roller 558 is rotatably driven by a suitable motor (unshown) to move belt 514. Rolls 544, 545, 548, 550, 554 and 556 are idler rolls provided to keep the belt taut and on track.

Initially, a portion of belt 514 passes through a primary color charging station 521 where an image forming subsystem 521A and imager 582 (which could be a laser) deposits charge of sufficient magnitude to form a latent image on the dielectric surface of belt 514. Then, belt 514 passes a first liquid development system 536 with the belt surface containing the latent image confronting but uniformly spaced from the system 536 to form a first development zone 511. Development system 536 passes a developing liquid comprising an insulating carrier and a predetermined concentration of toner particles into the development zone to develop the electrostatic image into a visible image as well known in the art.

Next, belt 514 is advanced to second primary charging station 523 where an electrostatic latent image corresponding to a second color is formed by imager 584, which image is subsequently developed by second development system 537 at second development zone 512. The belt 514 then advances past a third primary charging station 525 and third imager 586, followed by belt 514 passing a third development system 540, and third development zone 516. Then, belt 514 advances past a fourth and final black charging station 527 and fourth imager 588, followed by black development at development station 541 and fourth developing zone 517″. The second, third and fourth stations and associated development systems are substantially the same as the first mentioned corresponding station so additional details are omitted for brevity.

After full color development, belt 514 advances the developed full image contained in the surface thereof to a transfer station 563 where a sheet of copy paper 568 is advanced from a paper stack 569 along paper path 571 by a sheet feeder 566. The copy paper advances in synchronism with movement of the belt 514 so that the developed image and the sheet arrive simultaneously at transfer station 563 for transfer. After transfer, the copy sheet with transferred image thereon is advanced to a fusing station 570 which has a series of fuser rolls 570A that vaporize any remaining liquid carrier on the paper surface and permanently fuse the toner particles onto the copy sheet. Upon completion, the copy sheet is advanced to an output catch tray (unshown). A rotary cleaner 100 is provided downstream from transfer station 563 to remove any residuals, such as adhering toner particles or carrier fluid from belt 514 prior to creation of a new image. Rotary cleaner 100 may be opposed to an idler roller 556. Rotary cleaner 100 corresponds to the rotary cleaner disclosed in FIGS. 1-3. While a full color system has been shown, it is obvious that the invention also applies to monochrome printing and copying systems.

The liquid electrophotographic system of FIG. 5 operates at a predetermined process speed. The rotary cleaner is rotated at a speed commensurate with the process speed and preferably is rotated at a minimum rotation speed as set forth in equation 1 when the liquid is diluted and rotated at a minimum speed as set forth in equation 2 when the ink has a high solids content.

FIG. 6 depicts schematically an exemplary dry xerographic system to which the invention may also be particularly suited. As xerographic systems are well known, the various processing stations thereof will only be briefly described. A reproduction machine 600 is shown having a photoreceptor belt 610 having a photoconductive surface that serves as an image bearing surface. While a belt architecture is shown, the invention is equally applicable to a drum photoreceptor architecture. Photoreceptor belt 610 moves in the direction of arrow 612 to advance successive portions of belt 610 sequentially through the various processing stations disposed about the path of the belt. The belt 610 is entrained about a stripping roller 614, a tension roller 616, and a drive roller 620. Drive roller 620 is coupled to a suitable motor 621 by an appropriate linkage such as a belt drive (unshown). The belt 610 is maintained in tension by a pair of unshown springs that resiliently urge tension roller 616 against belt 610 with a desired force. Both stripping roller 614 and tension roller 616 are idler rollers that are rotatably mounted for free movement.

Initially, a portion of belt 610 passes through a charging station A, where a corona device 622 charges a portion of belt 610 to a relatively high, substantially uniform potential (which can be either positive or negative depending on application). At exposure station B, an original document is positioned face down on a transparent platen 630 for illumination with flash lamps 632. Light rays reflected from the original document are reflected through a lens 633 and projected onto the charged portion 611 of the photoreceptor belt 610 to selectively dissipate the charge thereon. This records an electrostatic latent image on the belt that corresponds to the informational area contained within the original document. Alternatively, a laser may be provided to imagewise discharge the photoreceptor belt 610 in accordance with stored electronic information.

Thereafter, belt 610 advances the electrostatic latent image to development station C, where at least one of two developer housings 634 and 636 is brought into contact with belt 610 for the purpose of developing the latent image. Housings 634 and 636 may be moved into and out of developing position by corresponding cams 638 and 640 selectively driven by motor 621. Each developer housing 634 and 636 supports a developing system such as magnetic rolls 642 and 644, which provides a rotating magnetic member to advance developer mix (i.e., carrier beads and toner) into contact with the electrostatic latent image. The electrostatic latent image attracts toner particles from the carrier beads, thereby forming toner powder images on the photoreceptor belt 610. If only a single color developing system is used, the second developer housing may be omitted.

Photoreceptor belt 610 then advances the developed latent image to transfer station D, where a sheet of support material such as paper copy sheets 649 is advanced into contact with the developed images on belt 610. A corona generating device 646 charges the copy sheet to the proper potential so that it becomes tacked to the photoreceptor belt 610 and the toner powder image is attracted from photoreceptor belt 610 to sheet 649.

After transfer, corona generator 648 charges the copy sheet to an opposite polarity to detach the copy sheet from belt 610, whereupon the copy sheet is stripped from belt 610 at stripping roller 614. Sheets of support material 649 are advanced to transfer station D from a supply tray 650. Sheets are fed from tray 650 with sheet feeder 652 and advanced to transfer station D along conveyor 656.

After transfer, the sheet continues from stripping roller 614 toward a fusing station E, which includes a fuser assembly 670 that permanently affixes the transferred toner powder images to the sheets. The fuser assembly may be a heated fuser roller 672 in pressure engagement with a backup roller 674. From the fuser, sheet 649 passes gate 662 to an output tray 680.

Residual particles remaining on the photoreceptor belt 610 after each copy is made are removed by cleaning station F, which includes the inventive rotary cleaner 100. A roll 690 may oppose cleaner 100. All of the various movements may be controlled by machine controller 696.

The dry xerographic system of FIG. 6 operates at a predetermined process speed. The rotary cleaner is rotated at a speed commensurate with the process speed and preferably is rotated at a minimum rotation speed as set forth in equation 1.

While the systems of the invention have been described in conjunction with the specific embodiments outlined above, it is evident that many alternatives, modifications and variations will be apparent to those skilled in the art. Accordingly, the exemplary embodiments are intended to be illustrative, not limiting. Various changes may be made without departing from the spirit and scope of the invention.

For example, the blades do not necessarily have to be continuous in their length and may be discontinuous. To prevent gaps in cleaning with such a configuration, discontinuous regions in adjacent blades should be offset so that the entire length of the surface is covered by at least one of the two or more blades that contact the surface at any one time.

Moreover, it is not necessary for the blade cleaner 100 to be fixedly mounted adjacent and in contact with surface 200. Rather, it is possible for rotary blade cleaner 100 to be pivotally or translatably movable toward and away from surface 200.

Further, while the base 120 and blades 110 may be integrally formed from a suitable material, it is also possible for base 120 and blades 110 to be formed of differing materials, with the blades 110 being bonded, adhered or otherwise affixed to base 120 so as to be radially provided around the periphery of base 120.

Additionally, while base 120 is preferably cylindrical, the invention is not limited to this and acceptable results may be achieved using a semispherical or other surface. However, in such a case, full rotation would not be achievable and an indexing mechanism would be required to index the cleaner back to a first blade when the cleaner has advanced to the last blade element.

Moreover, the inventive rotary cleaner is applicable as a cleaning tool for many general purposes, even those outside of the graphic arts or printing field, as the cleaner has been found to adequately clean residual materials of many types from a surface.

What is claimed is:

1. A multi-bladed rotary blade cleaner for cleaning a surface having residuals thereon, comprising:
a base having a predetermined periphery and a longitudinal axis; and
a plurality of radially extending blades spaced along the periphery by a predetermined spacing, wherein the blades have a predetermined length and are oriented at an angle relative to the longitudinal axis.

2. The multi-bladed rotary blade cleaner of claim 1, wherein the spacing is selected so that at least two adjacent blades contact the surface to be cleaned when in use, the blades being oriented to operate in a wiping mode.

3. The multi-bladed rotary blade cleaner of claim 1, wherein the blades are oriented along the longitudinal axis in a spiral fashion so that only a portion of a blade contacts the surface at any given time.

4. The multi-bladed rotary blade cleaner of claim 1, wherein the blades are formed from a resilient rubber material.

5. The multi-bladed rotary blade cleaner of claim 4, wherein the resilient rubber is a soft urethane.

6. The multi-bladed rotary blade cleaner of claim 5, wherein the soft urethane has a hardness of about 70 Shore A.

7. The multi-bladed rotary blade cleaner of claim 4, wherein the resilient rubber has a Young's modulus of about 1000 psi.

8. The multi-bladed rotary blade cleaner of claim 1, wherein only two blades contact the surface at one time.

9. The multi-bladed rotary blade cleaner of claim 1, wherein each blade has an extension length of about 7 mm.

10. A cleaning apparatus for cleaning residuals from a surface, comprising:
the multi-bladed rotary blade cleaner of claim 1; and
a driving source that rotates the multi-bladed rotary cleaner to advance a new blade into contact with the surface.

11. The cleaning apparatus of claim 10, wherein the driving source advances the rotary cleaner at a substantially constant speed.

12. An electrophotographic device comprising the cleaning apparatus of claim 10 in contact with an image bearing surface that may contain residuals.

13. The electrophotographic device of claim 12, wherein the image bearing surface includes liquid imaging material as residuals.

14. A xerographic device comprising the cleaning apparatus of claim 10 in contact with an image bearing surface that may contain residuals.

15. The xerographic device of claim 14, wherein the image bearing surface includes dry xerographic toner as residuals.

16. A method of cleaning a surface comprising the steps of:
providing the multi-bladed rotary cleaner of claim 1 in contact with a surface containing residuals so that at least one of the plurality of blades is in contact with the surface; and
driving the multi-bladed rotary cleaner at a predetermined rotation speed to clean residuals from the surface.

17. The method of claim 16, further comprising a step of washing residuals from the multi-bladed rotary cleaner.

18. The method of claim 16, wherein the surface being cleaned is an image bearing surface and the residuals include toner particles.

19. The method of claim 18, wherein the toner particles include a liquid carrier.

20. The method of claim 18, wherein the toner particles include dry toner particles.

21. A method of cleaning a photoreceptive surface of residuals in a xerographic or electrophotographic device comprising the steps of:
driving the photoreceptive surface at a process speed of Vₚᵣ;
providing the multi-bladed rotary cleaner of claim 2 in contact with a surface containing residuals; and
driving the multi-bladed rotary cleaner at a predetermined rotational speed V_{b} to clean residuals from the surface.

22. The method of claim 21, wherein the residuals are one of xerographic toner and low solids content ink and the rotational speed V_{b} of the rotary cleaner is about Vₚ/5.

23. The method of claim 21, wherein the residuals are pasty inks having a high solids content and the rotational speed V_{b} of the rotary cleaner is about Vₚ/2.
